(19) United States
(12) Patent Application Publication
(10) Pub. No.: US 2009/0073680 A1
(43) Pub. Date: Mar. 19, 2009

(54) INDUCTIVE LIGHTING FOR 2' X 2' AND 2' X 4' FIXTURES

(76) Inventor: Ruben SANDOVAL, Yucaipa, CA (US)

Correspondence Address: BUHLER ASSOCIATES;BUHLER, KIRK A., 1101 CALIFORNIA AVE., SUITE 208, CORONA, CA, 92881, US

(21) Appl. No.: 12/197,436

(22) Filed: Aug. 25, 2008

Related U.S. Application Data
(60) Provisional application No. 60/993,559, filed on Sep. 13, 2007.

(51) Int. Cl. F21V 23/02

(52) U.S. Cl. 362/216; 362/221

(57) ABSTRACT

A lighting fixture where the lighting fixture uses inductive lighting technology or self ballasting lighting elements with one or a plethora of efficient light elements. The lighting fixture is used where high bay or low bay lighting may be used, but incorporates multiple light sources to provide an equivalent light intensity. The invention may include a hanging system that allows the entire assembly to be wired into a new or existing building and supply self ballasting lights, or ballast box and the dome or reflector. This fixture uses one or more high efficiency inductive lighting in similar 2 ft by 2 foot or 2 foot by 4 foot housing. A ballast box is secured to the reflector or dome retainer making the fixture a direct replacement for similar size and shape inductive fixtures.

### CROSS REFERENCE TO RELATED APPLICATIONS

This application claims the benefit of Provisional 60/993,559 filed Sep. 13, 2007 and applicants co-pending U.S. application Ser. No. 11/282,274 filed Nov. 18, 2005 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to industrial and high bay lighting fixture using one or more inductive light elements. More specifically the invention is designed to replace a high-bay, low-bay warehouse or similar lighting fixture. The invention may include a hanging system that allows the entire assembly to be wired into a new or existing building and supply self ballasting lights, or ballast box and the dome or reflector. This fixture uses one or more high efficiency inductive lighting in similar 2 ft by 2 foot or 2 foot by 4 foot housing. A ballast box is secured to the reflector or dome retainer making the fixture a direct replacement for similar size and shape inductive fixtures.

2. Description of Related Art Including Information Disclosed Under 37 CFR 1.97 and 1.98

Lighting is used to provide light when it is dark or to provide supplemental lighting for a dark area. Often in large buildings, overhead lighting is provided from lights placed near the ceiling of the building and the light is directed downward. Most light bulbs used in these lighting installations are inefficient, and a portion of the energy used in these lights is expended in heat. In the summer, the heat must be cooled with the building air conditioning system. The maintenance cost of these bulbs is also high due to the cost of government imposed lamp disposal fee, the short lifespan and the rapid degradation of 30 to 40% after a year. What is needed is a new lighting fixture that includes the ballast and may further include the dome that can easily be replaced with existing fixtures simply by having a new energy efficient fixture. The ballast is provided with multiple high efficiency fluorescent or inductive lighting bulbs that provide equivalent or superior illumination with improved efficiency and a reduction in the amount of heat that is generated. The invention proposed provides a solution to all the listed requirements.

U.S. Pat. No. 5,497,048 issued to Burd is for a fluorescent bulb that has multiple fluorescent elements located within the light bulb. This invention provides the equivalent energy efficiency and an equivalent amount of light, but the bulb is a custom light bulb, and the light bulb is not manufactured in high volume. The invention does not provide multiple efficient light bulbs that are cost effective and readily available.

U.S. Pat. No. 5,541,477 issued to Maya et al. is for a single fluorescent bulb that also has multiple fluorescent bulb elements that are connected into a single screw-in base. This invention provides the equivalent energy efficiency and the equivalent amount of light, but the bulb is a custom light bulb, and the light bulb is not manufactured in high volume. The invention does not provide multiple efficient light bulbs that are cost effective and readily available.

U.S. Pat. No. 4,664,465 issued to Johnson et al. is for a bulb with a clip attached that allows the bulb to be attached to a metal strip. The patent covers the clip connected to a hollow tube that can extend from a vertical or horizontal surface. This invention uses a single bulb connected to an elongated metal tube or neck. The invention is intended for wiring to an electrical power source. The invention does not include multiple light sockets that connect into a base that can be screwed into a lamp base.

U.S. Pat. No. 6,964,502 issued to Neal R. Verfuerth on Nov. 15, 2005 discloses a retrofit fluorescent light tube fixture apparatus. While this retrofit apparatus that fits into older fluorescent fixtures it simply replaces one fluorescent lighting fixture with another fluorescent lighting fixture that is prone to the same efficiencies and life expectancy of that it replaces.

U.S. Pat. No. 7,070,303 issued to Charles E. Kassey et al. on Jul. 4, 2006 discloses a fluorescent lighting fixture with improved up lighting the bulb receiving portion of the fixture is curved so the outer bulbs have a reflector that is not parallel with the ground. While this configuration provide for more up lighting the illumination elements are still fluorescent bulbs.

The ideal product would be used where high or low bay lighting would be used that might require a ballast or self ballast energy efficient lighting solution for operation. Standard high efficiency light bulbs could be inserted into the multiple sockets to provide equivalent light intensity at a significant reduction in the energy being used. A single or multiple inductive light elements also provides improved illumination with a longer life expectancy of 500%. The integration of the fixture with the dome as one piece further reduces the components and the cost of manufacturing.

### BRIEF SUMMARY OF THE INVENTION

It is an objective of the present invention to provide an energy efficient lighting system that replaces standard 2 foot by 2 foot and 2 foot by 4 foot with similarly sized and shaped inductive lighting fixtures. The fixture may also include a dome or other reflector or fixture design to focus the light downward. A standard 100-watt incandescent bulb uses 100 watts of energy, a fluorescent light (or inductive light) bulb that provides the same amount of light only requires about 20 to 25 watts of energy. Fluorescent light consume 45 to 50% less energy than a standard incandescent light bulb. The light from fluorescent light is similar or superior to the light from an incandescent light, and can be tinted to provide different shades to simulate other lighting sources. The fixture requires the installation onto the rafters or ceiling of the building where it is installed to produce light that is emitted above and below the lighting fixture as well as out the sides of the lighting fixture. A reflector dome or cover located in the lighting fixture helps to focus the lighting down to where the light is needed. An inductive light source provides an improved lighting source 20 to 30% brighter than standard fluorescent bulbs with increased efficiency and 50% longer bulb life.

A warehouse typically uses 450-465 watt incandescent, halogen or similar light bulb and ballast system. The proposed invention replaces the single 400-watt light bulb with five fluorescent or inductive self ballasting fluorescent lights providing the same or more illumination. The standard warehouse light uses 450-465 watts to produce the light. The five self ballasting fluorescent lights only require 240 to 250 watts of energy. An inductive light source only requires 200 to 220 watts of energy to produce the same amount of illumination, saving 170 to 255 watts of energy that would be spent in heat. A 400 watt metal halide light operates at 1750 degrees of heat, where a fluorescent or inductive lamp operates at 190 to 210 degrees. Inside an air conditioned building the 170 to 255 watts of heat would need to be cooled with the air conditioning system within the building. The savings come from three places, first the more efficient lights, second from air conditioning costs and third, from less maintenance costs. In addition, there can be safety benefits from less ultraviolet rays, and for less chance that the fluorescent bulbs will explode. Inductive lighting provides improved efficiency and savings where a standard warehouse light uses 450-465 watts to produce the light. One to three inductive lights may require as little as 200 watts of energy to produce more light than a standard warehouse light and will provide saving of 250 to 265 watts of energy and 1500 degrees of heat would be spent in heat. Inside an air conditioned building the 1750 degrees of heat would need to be cooled with the air conditioning system within the building. The savings come from three places, first the more efficient lights, and second from air conditioning costs, induction lamps further reduce re-lamping costs by 500%, or mounted separately to 600% reduce, and third the maintenance and government imposed hazardous waste disposal costs.

When the new lighting fixture is installed into a new or existing building the enclosure for the ballast may be eliminated. The multiple bulbs can be as little as two to as many bulbs that are required to provide equivalent light output and wattage drop for the incoming voltage. If the lighting is 120 VAC or 277 VAC, multiple 120 VAC or 277 VAC fluorescent, 120 VAC, 277 VAC inductive lighting bulbs can be used to achieve equivalent or superior light output. Other light bulbs operating at up to 480 VAC with the capability of being dimmed are contemplated.

The lighting fixture can be separated from the ballast box and mounted or hung separately where the installation calls for reducing the height by as much as 40%. This allows improved cosmetics, height without compromising the efficiency or operation of the fixture. The components of the fixture are designed to allow the parts to be connected or separated in the field without requiring additional components.

One problem with placing a torus lighting element within the dome is the shadow that exists from the light of the lighting element blocking the light emitted from the back side of the lighting element. Different light diameters and different dimensions will yield varying reflective angles that will reflect the light from behind the lighting element to the front of the lighting fixture to eliminate the shadow that can be appear under the lighting dome. The internal geometry to minimize or eliminate the shadow. The proposed lighting apparatus minimizes the blocked light by reflecting light around the torus, inductive lighting element.

One of the most common sizes of lighting is with 2 foot by 4 foot fluorescent lighting. This size lighting is found around the world to illuminate work stations, garages and factories. The proposed inducting lighting application is a simple direct replacement of these lighting fixtures that has a similar size foot print and can directly replace older fluorescent fixtures with a variety of illumination intensities.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 is a sectional view of a high bay lighting fixture using inductive lighting elements.

FIG. 2 is a detailed cross sectional view of the lighting fixture from FIG. 7 showing the retaining tab.

FIG. 3 is a perspective view of the lighting fixture showing the arrangement of the components.

FIG. 4 is a view showing the light transmission and reflection rays of the dome and deflector

FIG. 5 is a sectional view of a 2 foot×2 foot lighting fixture using an inductive lighting element.

FIG. 6 is a perspective view looking up into the 2 foot×2 foot inductive lighting fixture.

FIG. 7 is a perspective view looking up into a 2 foot×4 foot inductive lighting fixture with two lighting elements.

FIG. 8 is a perspective view looking up into a 2 foot×4 foot inductive lighting fixture with three lighting elements.

FIG. 9 is a perspective view looking up into a 2 foot×4 foot inductive lighting fixture with four lighting elements.

FIG. 10 is a perspective view looking up into a 2 foot×4 foot inductive lighting fixture with two horse shoe type inductive lighting elements.

FIG. 11 is a perspective view looking up into a 2 foot×4 foot inductive lighting fixture with four inductive lighting elements where the fixture provides enhanced side lighting.

FIG. 12 is a perspective view looking down onto the top of a 2 foot×4 foot inductive lighting fixture showing the electrical connections.

FIG. 13 is a perspective exploded view of a 2 foot×4 foot inductive lighting fixture showing the various components.

FIG. 14 is a perspective assembled view of a 2 foot×4 foot inductive lighting fixture showing the various components shown looking into the inward formed housing.

FIG. 15 is a perspective exploded view of a 2 foot×2 foot inductive lighting fixture showing the various components.

FIG. 16 is a perspective assembled view of a 2 foot×2 foot inductive lighting fixture showing the various components shown looking into the inward formed housing.

FIG. 17 is a perspective view of the outside of a 2 foot×4 foot inductive lighting fixture shown with up light openings.

FIG. 18 is a perspective view of the outside of a 2 foot×2 foot inductive lighting fixture shown with up light openings.

### DETAILED DESCRIPTION OF THE INVENTION

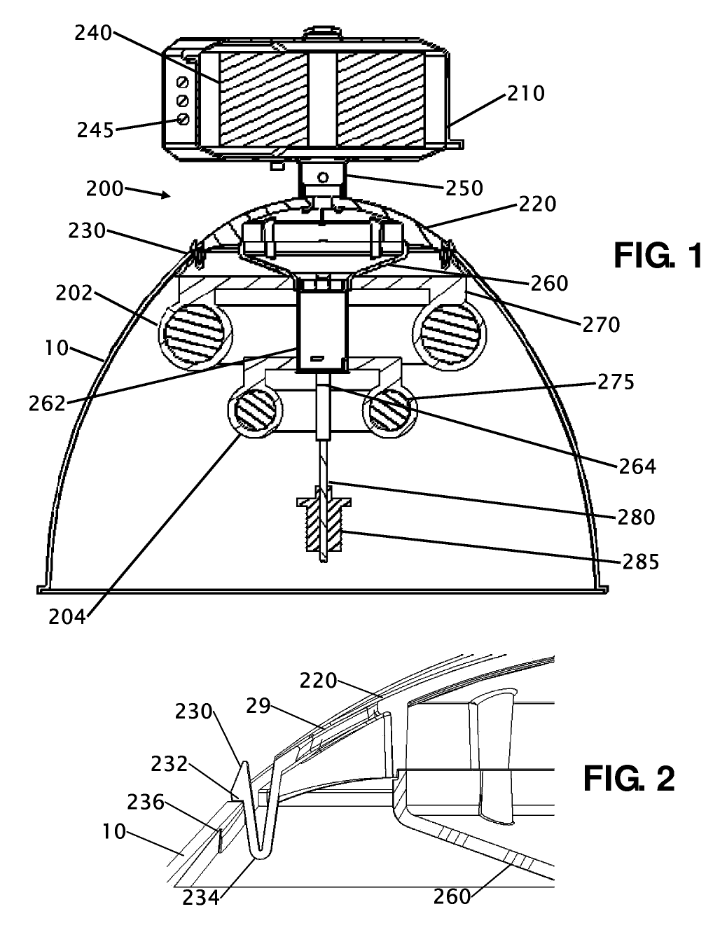

FIG. 1 shows a sectional view of a bay lighting fixture using inductive lighting elements 200. The reflective or focusing dome 10 directs light from the lighting elements 202 and 204 downward so more of the light shines where desired. This figure show two lighting elements of different size, but the size, shape and output illumination of the lighting elements can be the same or different depending upon the desired amount of light that is required. The reflective or focusing dome 10 is attached to the housing with clips or fasteners 230. The dome rests on the dome retainer 220, where gravity and the retaining tab 230 lock the dome in place. The shape and configuration of these clips is shown and described in more detail with FIG. 2 below. The dome retainer is connected or integrated with a connecting tube 250 that supports the lighting and dome in addition to providing a conduit for wiring. The connecting tube 250 is attached to the ballast enclosure. In some configurations contemplated, the ballast box may be empty, when the ballast is included with the lighting elements. The ballast 240 is shown housed in the ballast box 210. One configuration of electrical connection to the ballast is with screw terminals 245, but the wiring connection(s) could be made with wire nuts or spring clips where the wires are pushed into the terminals and retained by spring force that both retain the wires and provide electrical connection between the ballast and the external wiring. An electrical connection from the ballast extends through connecting tube 250, into the dome retainer 220 for connection with the lighting elements 202, 204 or lighting socket for the lighting elements. Locking bars 270 and 275 hold the inductive lighting elements in place within the dome and on the lower cover 260 that is capped with an extender 262, and an extender cap 264. The extender allows the placement and retention of the additional lighting element 204 that holds locking bar 275.

A lower cover 260 encloses the lower portion of the housing to protect the electrical wiring. The ballast box 210, dome retainer 220, and the lower cover 260 can be fabricated using a number of different methods including but not limited to casting, machining, drawing, forming or molding. In the preferred embodiment the part are made from an injection molded process. The materials for these components can also be variety of types including but not limited to plastics, resins, ceramic, ferrous and non-ferrous materials, with the qualities of strength, heat resistance. A safety locking mechanism 285 is installed on the end of retaining cable 280 to hold the light fixture in position. While in this figure the retaining mechanism 285 is shown extended from the cable 280, upon installation the safety device is secured against the bottom of the lighting fixture.

FIG. 2 is a detailed cross-sectional view of the lighting fixture from FIG. 1 showing the retaining tab 230. The reflective or focusing dome 10 is shown resting upon a portion of the dome retainer 220. For installation, the dome is brought over the dome retainer 220, the retaining tabs 230 will flex inward from the hinge area 234 allowing the dome 10 to pass by the clip, and then spring back into position locking the dome 10 under the tab at point 232. Once the dome is in position, gravity, in addition to the clips 230 will keep the dome resting on the dome retainer at location 236 and all around the dome retainer. The lower housing 260 is shown in position under the dome retainer protecting the wiring connections. Vent 29 is shown in this view as it passes through the dome retainer. The vents are a critical part of the design because they allow heat from the room and from the lights to vent out of the fixture.

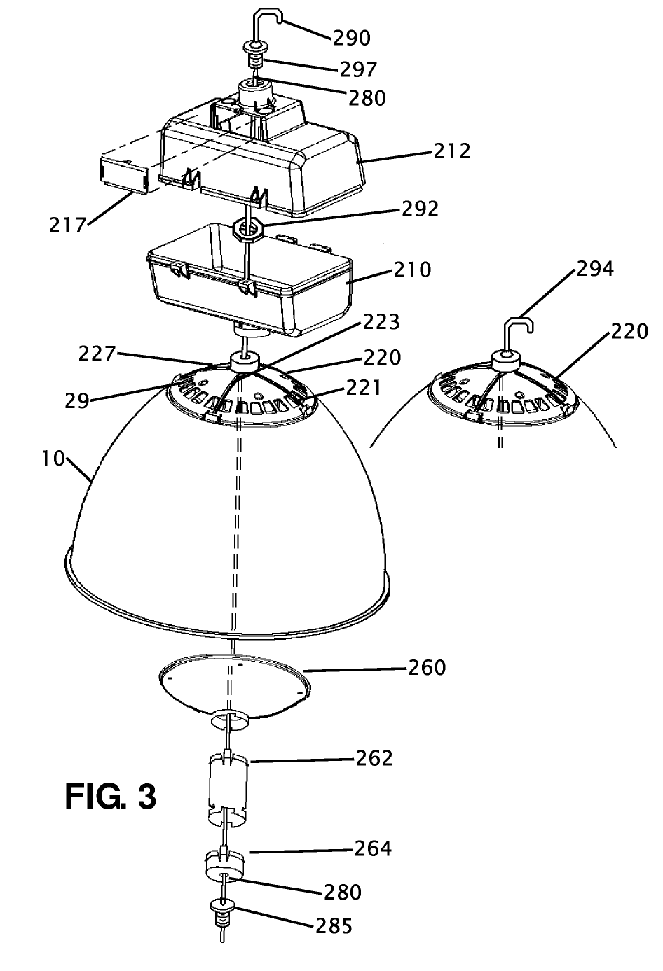

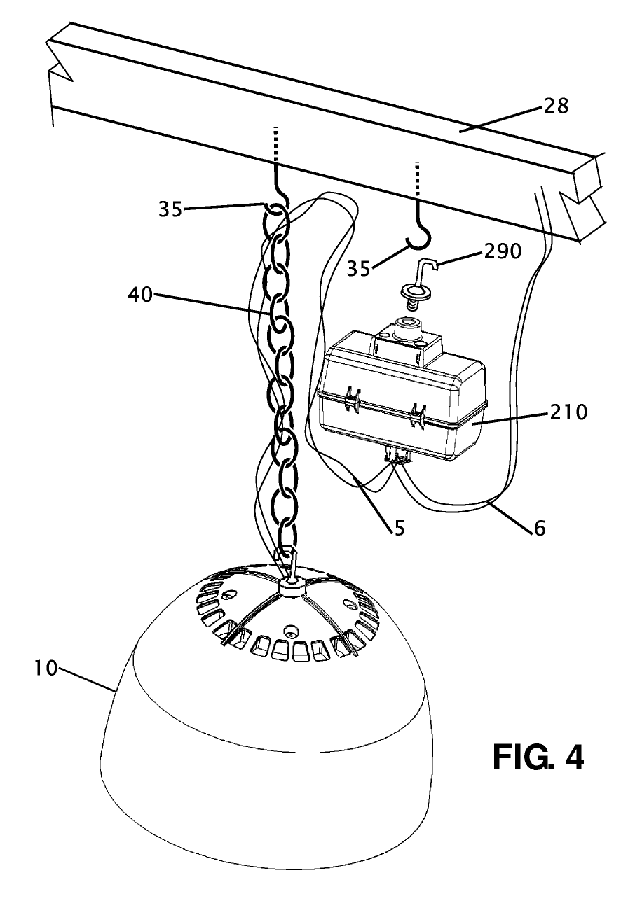

FIG. 3 is a perspective view of the lighting fixture showing the arrangement of the components. A retaining cable 280 passes through the entire lighting fixture and is secured with a safety line 285 located at the end of the cable. The top portion of the cable 280 is attached to a hook 290 that can be secured to the ceiling or joists of a building. The bottom portion 297 of the hanging hook 290 is secured to the ballast box with a nut 292 that is threaded onto the end of the hook at 297 from inside the ballast box. In an alternate mounting embodiment the hook 294 is connected to the top of the dome retainer 220. The dome 10 is shown below the dome retainer 220. A seams 221, 223, 227 are shown in this figure. The seam allows the dome retainer to be fabricated in multiple sections that can be connected. In the embodiment shown, the dome retainer is made from four pieces. In another contemplated embodiment, the dome retainer and at least a portion of the ballast box is made from a single component. The enclosure for a ballast is shown located above the lighting fixture with a top housing 212, of the ballast box 210 and an access cover 217. In this embodiment the top and bottom housings are connected with a hinged arrangement with a closure. In yet another contemplated embodiment, the ballast box dome retainer and connecting pipe are made in two halves. This view shows the dome retainer essentially as a dish shape but other similar shapes can be used. The lower cover 260 is shown under the dome and it is attached to the dome retainer. The design of the lower cover is critical to the transmission of light around the lighting element(s). A description of the design requirement to reflect light around the lighting elements is shown and described with FIG. 4. The extender 262 is shown below the lower cover and attaches to the lower cover. The extender cap 264 is shown below the extender and closes the opening in the bottom of the extender 262.

The disk shape is ideal because it allows for any heat to be channeled up through the lighting fixture. Vents 29 are shown around the dome retainer. In the embodiment shown the vents are essentially rectangular in shape, but other shapes are contemplated to include but not be limited to rectangular, circular, elliptical vents or combination thereof.

FIG. 4 is an isometric view of a one piece light dome 10 with a separate ballast box 210. In this embodiment the dome is cast from a clear, multi-colored, translucent, or opaque material and is then internally coated or painted with an aluminum or chrome to provide a reflective surface. The dome is made from a polycarbonate abs or other similar material as opposed to being cast or spun out of aluminum or other metal. The ballast box 210 is shown mounted separately from the lighting dome, and prototypes have been made with a separation of 15 feet between the ballast and the lighting elements. The wiring from the buildings electrical system 6 enters into the ballast box 210 and, after the voltage is converted, a separate set of wiring 5 connects to the lighting fixture 10. This entire lighting system is attached to the ceiling or joist 28 of the building from hooks 35, chain 40 and or hooks integrated into the lighting or ballast enclosure 290.

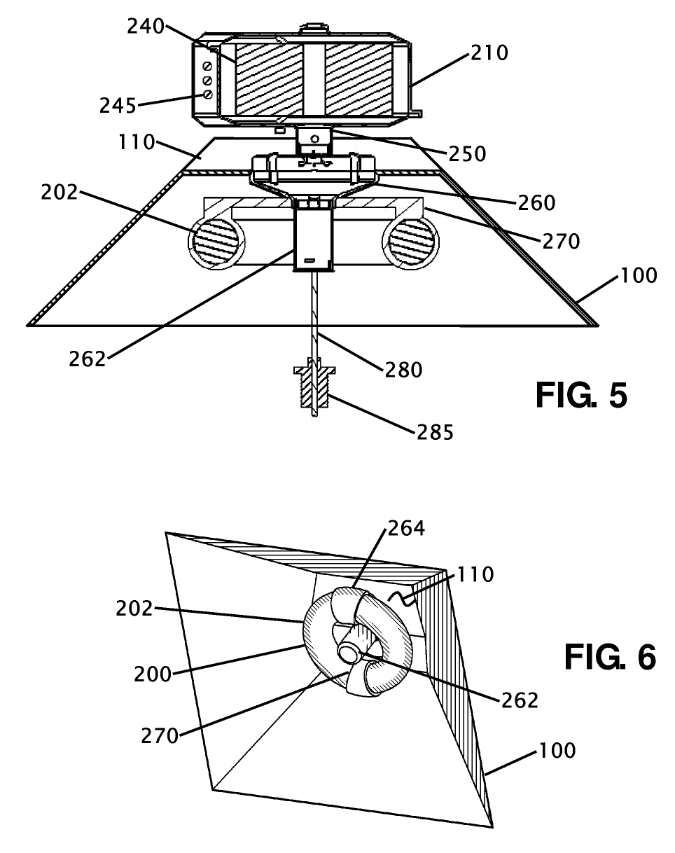

FIG. 5 is a sectional view of a 2 foot×2 foot lighting fixture 200 using an inductive lighting element. While the majority of fluorescent fixtures are configured in a 2 foot by four foot configuration a number of fluorescent fixtures is 2 foot by 2 foot in size. In this embodiment the reflector is a bent reflector 100 is formed from sheet metal. The inside surface of this reflector is preferably painted white or other similar reflective color or a silver color to reflect the light. The inductive lighting element 202 is attached to the bent reflector with clips or fasteners. It is also contemplated that the lighting fixture is clamped through the bent reflector 100 using the cover and the ballast box.

The connecting tube 250 is attached to the ballast enclosure. In some configurations contemplated, the ballast box may be empty, when the ballast is included with the lighting elements. The ballast 240 is shown housed in the ballast box 210. One configuration of electrical connection to the ballast is with screw terminals 245, but the wiring connection(s) could be made with wire nuts or spring clips where the wires are pushed into the terminals and retained by spring force that both retain the wires and provide electrical connection between the ballast and the external wiring. An electrical connection from the ballast extends through connecting tube 250, into the dome retainer 220 for connection with the lighting elements 202 or lighting socket for the lighting elements. Locking bars 270 hold the inductive lighting elements in place within the dome and on the lower cover 260 that is capped with an extender 262.

A lower cover 260 encloses the lower portion of the housing to protect the electrical wiring. The materials for these components can also be variety of types including but not limited to plastics, resins, ceramic, ferrous and non-ferrous materials, with the qualities of strength, heat resistance. A safety locking mechanism 285 is installed on the end of retaining cable 280 to hold the light fixture in position. While in this figure the retaining mechanism 285 is shown extended from the cable 280, upon installation the safety device is secured against the bottom of the lighting fixture.

FIG. 6 is a perspective view looking up into the 2 foot×2 foot inductive lighting fixture. The fixture is constructed with a bent metal reflector 100. While a bent metal reflector is shown and described, because it is the most common and cost effective, other materials are contemplated including but not limited to glass, paper and plastics. The sides of the reflector 100 are bent to ensure more of the light shines downward. Inside the reflector the top of the fixture has an inside bend 110 to spread the light from the top of the inductive lighting element 202. This figure shows the electromagnet(s) 160 that encircle a portion of the illumination torus. The end of the extender 262 can be seen extending through the inductive lighting element 202. Locking bar(s) 270 hold the inductive lightning element 202 in the fixture and provide some protection from vibration and shock.

FIG'S. 7-9 are perspective views looking up into a 2 foot×4 foot lighting fixture with two, three and four elliptical lighting elements. While a 2 foot×4 foot is described other sizes are contemplated as previously described or needed based upon the design requirement including longer, wider or narrower designs. This is the most common size fluorescent lamp and this application provides for a variety of different inductive lamp configurations and lighting intensities in the same footprint. The inductive lights can be the same intensity or different intensities depending upon the desired amount of light. The fixture is constructed with a bent metal reflector 100. While a bent metal reflector is shown and described, because it is the most common and cost effective, other materials are contemplated including but not limited to glass, paper and plastics. The sides of the reflector 100 are bent to ensure more of the light shines downward. While only one bend angle is shown in the figures other bend angles are contemplated that optimize the light for a particular installation. Inside the reflector the top of the fixture has an inside bend 110 to spread the light from the top of the elliptical lighting element 140. This figure shows the electromagnet(s) 160 that encircle a portion of the elliptical lighting element 140. A portion of the ballast 170 is shown mounted to the top of the bent reflector 100. In the embodiments shown one ballast is used with each inductive lamp, but it is contemplated that a single ballast can operate multiple lamps.

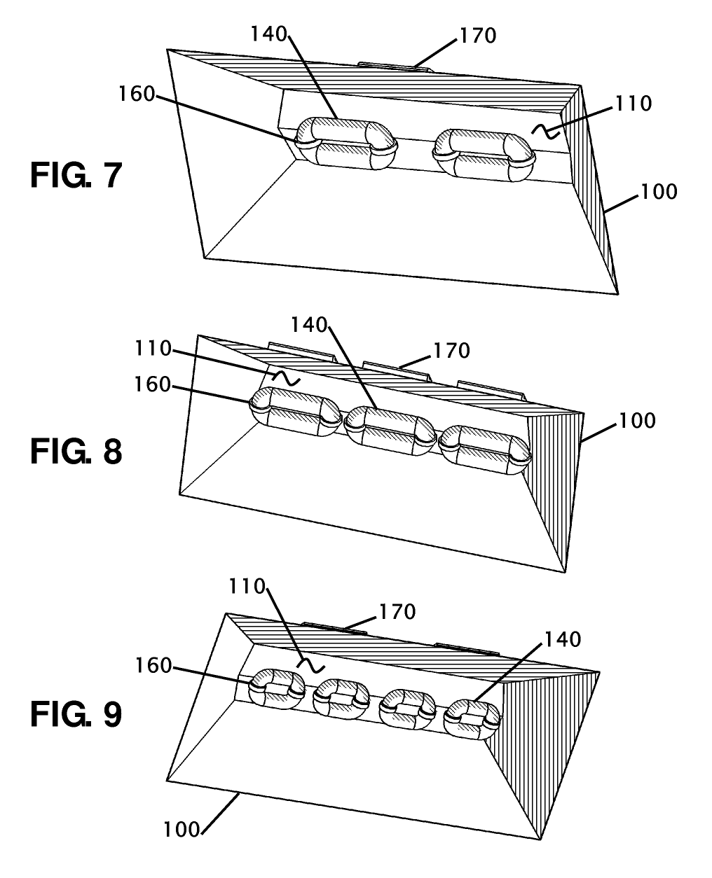

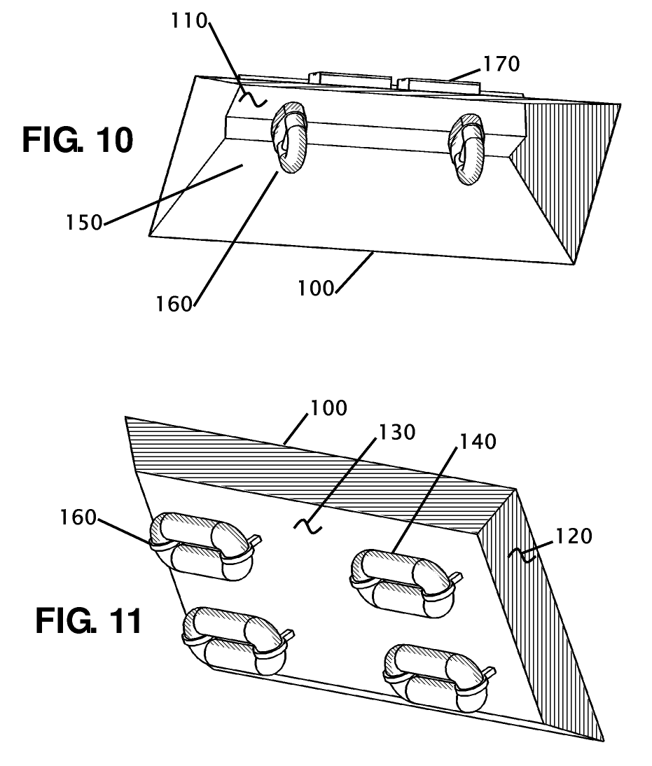

FIG. 10 is a perspective view looking up into a 2 foot×4 foot lighting fixture with two horse shoe type inductive lighting elements 150. These inductive illumination elements 150 are shaped like a horse shoe and have the electromagnet 160 located in the middle of the horse shoe. The bent reflector 100 is a similar construction as shown and described in FIGS. 7-9 where with an inside bend 110 for reflecting light from the underside of the inductive lighting elements 150. A portion of the ballast 170 is shown mounted to the top of the bent reflector 100. In the embodiments shown one ballast is used with each inductive lamp, but it is contemplated that a single ballast can operate multiple lamps.

FIG. 11 is a perspective view looking up into a 2 foot×4 foot lighting fixture with four lighting elements where the fixture provides enhanced side lighting. The outside dimensions of the bent reflector 100 are similar to the size described in FIGS. 7-10 but because the outside of the fixture is bent up 120 the light can spread upward while the majority of the light is reflected downward. The bottom of the reflector 130 is shown as an essentially flat surface, but other embodiments are contemplated wither the bottom reflector 130 is corrugated, bent or has a lamp conforming configuration. Four elliptical lighting element(s) 140 are shown in this figure but it is contemplated that as few as one to more than four can be used based upon the amount of light that is required. This figure shows the electromagnet(s) 160 that encircle a portion of the elliptical lighting element 140.

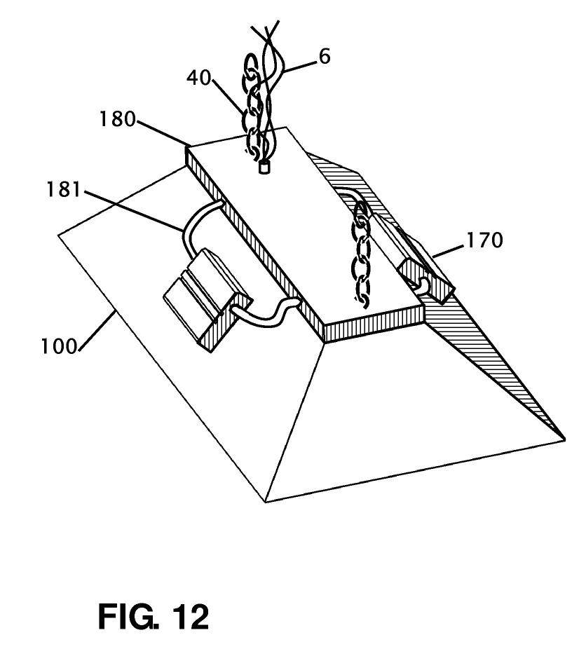

FIG. 12 is a perspective view looking down onto the top of a 2 foot×4 foot inductive lighting fixture showing the electrical connections. All of the lighting fixtures require some form of electrical connection the incoming power 6. In the embodiment shown a junction box 180 exists across the top of the bent reflector 100. The fixture has two inductive lamps (not shown) and two ballasts 170 are shown mounted to the top of the bent reflector 100. Conduit 181 connects the ballasts to the junction box 180 and each of the inductive lamps. This figure shows chains 40 for connecting the fixture to a ceiling or joists. While chain is shown in this figure other connection methods are contemplated including but not limited to pipe, cable, rods T-bar or drop ceiling connections.

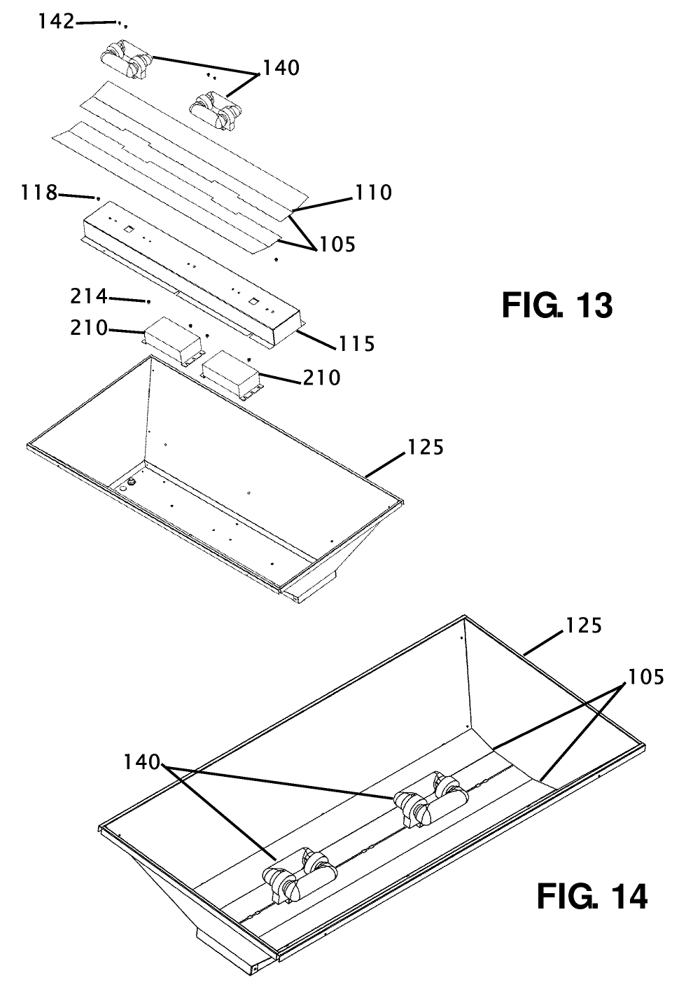

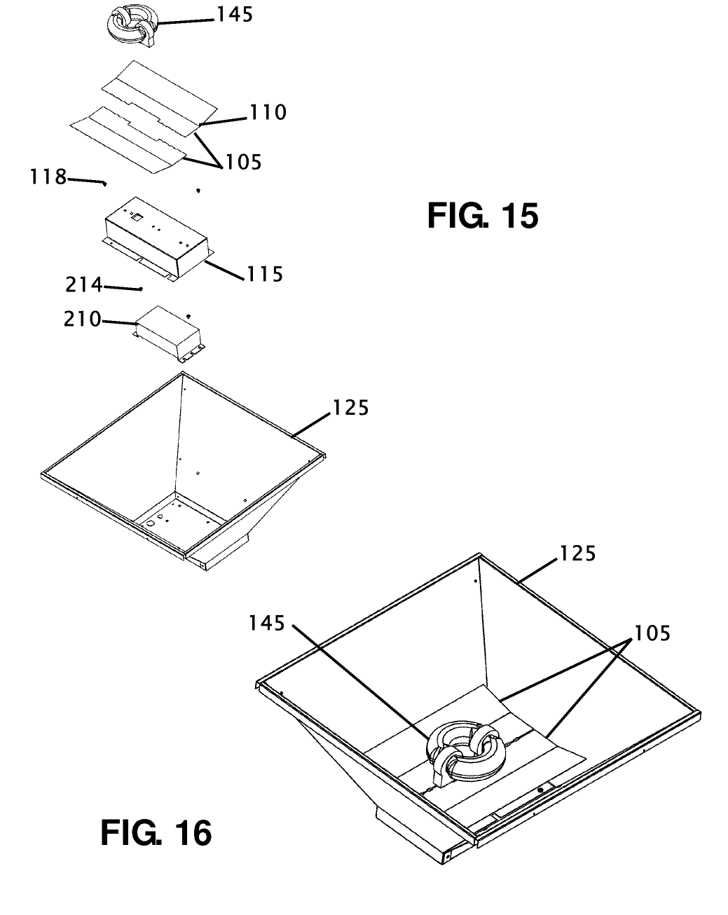

FIG. 13 is a perspective exploded view of a 2 foot×4 foot inductive lighting fixture showing the various components and FIG. 14 is a perspective assembled view of a 2 foot×4 foot inductive lighting fixture showing the various components shown looking into the inward formed housing. FIG. 15 is a perspective exploded view of a 2 foot×2 foot inductive lighting fixture showing the various components and FIG. 16 is a perspective assembled view of a 2 foot×2 foot inductive lighting fixture showing the various components shown looking into the inward formed housing. These four figures show an inductive two foot by two foot lighting fixture and a two foot by four foot inductive lighting fixture. The housing is an inward formed housing 125 having an essentially square or rectangular outer periphery formed as a new or replacement fixture where a fluorescent lighting would be used. In the preferred embodiment the fixture housing and various other components are formed from sheet metal.

The inward formed housing 125 has a reflector 105 formed from two separate halves secured within the inward formed housing 125. The reflector(s) are bent 110 at an angle of between 13 and 15 degrees to focus the majority of the illumination downward and out of the housing 125. A ballast cover 115 is mounted on the inward formed housing 125. At least one ballast 210 is secured between the ballast cover 115 and the inward formed housing 125. In one preferred embodiment the ballast 210 is located between the reflector 115 and the inward formed housing 125. In another preferred embodiment the ballast cover 115 or covers and the ballast or ballasts is located on an outer surface of the inward formed housing 125. The ballast(s) 210 is secured with screws or other similar fasteners such as but not limited to clips or springs 214. The ballast cover 115 is secured with screws or other similar fasteners such as but not limited to clips or springs 118. The inductive lighting lamp(s) 140 or 145 is electrically connected to the ballast(s) 210 and mechanically secured 142 to the reflector(s) 105 such that when sufficient electrical power is applied to the ballast(s) 210, the ballast(s) 210 will provide electrical power to the inductive lamp(s) 140 or 145 to provide illumination.

One ballast can be used to operate more than one inductive lighting lamp, but in the embodiment where more than one ballast and more than one inductive lighting lamp is used, each ballast and each associated inductive lighting lamp is separately controllable for illumination intensity to reduce power consumption. Inductive lamps are individually or collectively controllable to vary the illumination intensity from each inductive lamp using a dimmer.

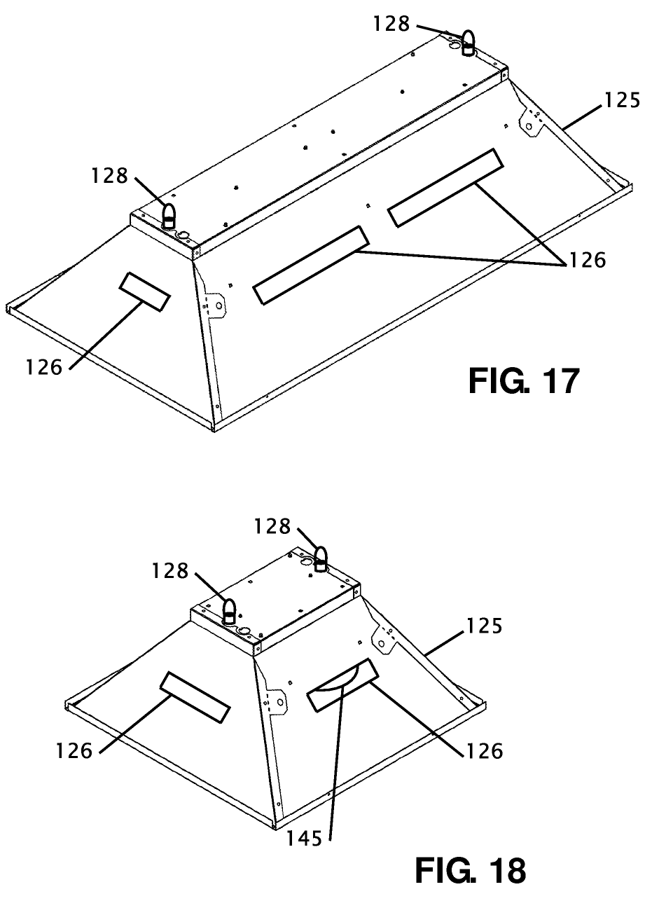

FIG. 17 is a perspective view of the outside of a 2 foot×4 foot inductive lighting fixture shown with up light openings 126 and FIG. 18 is a perspective view of the outside of a 2 foot×2 foot inductive lighting fixture shown with up light openings 126. These figures also show hanging loops 128 for securing the fixtures by chain, drop ceiling or other similar methods. These outside views of the inductive lighting fixture 125 shows at least one opening 126 in the inward formed housing 125 as a means for the function of providing side and or up lighting from the fixture. In FIG. 18 a portion of the circular inductive lighting element 145 is visible. Various hanging methods and apparatus are contemplated to secure the fixture to a ceiling. These methods include but are not limited to hooks 128, tabs, flanges or eye holes to hang the fixture or suspend the fixture in a drop or suspended manner.

Thus, specific embodiments and applications of a lighting and replacement light fixture have been disclosed. It should be apparent, however, to those skilled in the art that many more modifications besides those described are possible without departing from the inventive concepts herein. The inventive subject matter, therefore, is not to be restricted except in the spirit of the appended claims.

1. An inductive two foot by two foot lighting fixture comprising:
an inward formed housing having an essentially square outer periphery;
said inward formed housing having a reflector secured within said inward formed housing;
a ballast cover mounted on said inward formed housing;
at least one ballast secured between said ballast cover and said inward formed housing, and
an inductive lighting lamp electrically connected to said at least one ballast and mechanically secured to said reflector such that when sufficient electrical power is applied to said at least one ballast, said at least one ballast will provide electrical power to said at least one inductive lamp to provide illumination.

2. The inductive lighting fixture according to claim 1 wherein said fixture is configured as a replacement for a two foot by two-foot fluorescent light fixture.

3. The inductive lighting fixture according to claim 1 wherein said ballast is located between said reflector and said inward formed housing.

4. The inductive lighting fixture according to claim 1 wherein said ballast cover and said ballast is located on an outer surface of said inward formed housing.

5. The inductive lighting fixture according to claim 1 wherein said inward formed housing is made from sheet metal.

6. The inductive lighting fixture according to claim 1 wherein said inward formed housing further includes at least one opening in said inward formed housing as a means for the function of providing up lighting from said fixture.

7. The inductive lighting fixture according to claim 1 wherein said housing further includes elongated tabs extending from said housing as a means for the function of hanging said fixture.

8. The inductive lighting fixture according to claim 1 wherein said reflector is bent with an angle of between 13 and 15 degrees.

9. The inductive lighting fixture according to claim 1 wherein when more than one ballast and more than one inductive lighting lamp is used, each said at least one ballast and said at least one inductive lighting lamp is separately controllable for illumination intensity.

10. The inductive lighting fixture according to claim 1 wherein illumination intensity from said inductive lamp is variable and dimmable.

11. An inductive two foot by four foot lighting fixture comprising:
an inward formed housing having an essentially square outer periphery;
said inward formed housing having a reflector secured within said inward formed housing;
a ballast cover mounted on said inward formed housing;
at least one ballast secured between said ballast cover and said inward formed housing, and
an inductive lighting lamp electrically connected to said at least one ballast and mechanically secured to said reflector such that when sufficient electrical power is applied to said at least one ballast, said at least one ballast will provide electrical power to said at least one inductive lamp to provide illumination.

12. The inductive lighting fixture according to claim 11 wherein said fixture is configured as a replacement for a two foot by four foot fluorescent light fixture.

13. The inductive lighting fixture according to claim 11 wherein said ballast is located between said reflector and said inward formed housing.

14. The inductive lighting fixture according to claim 11 wherein said ballast cover and said ballast is located on an outer surface of said inward formed housing.

15. The inductive lighting fixture according to claim 11 wherein said inward formed housing is made from sheet metal.

16. The inductive lighting fixture according to claim 11 wherein said inward formed housing further includes at least one opening in said inward formed housing as a means for the function of providing up lighting from said fixture.

17. The inductive lighting fixture according to claim 11 wherein said housing further includes elongated tabs extending from said housing as a means for the function of hanging said fixture.

18. The inductive lighting fixture according to claim 11 wherein said reflector is bent with an angle of between 13 and 15 degrees.

19. The inductive lighting fixture according to claim 11 wherein when more than one ballast and more than one inductive lighting lamp is used, each said at least one ballast and said at least one inductive lighting lamp is separately controllable for illumination intensity.

20. The inductive lighting fixture according to claim 11 wherein illumination intensity from said inductive lamp is variable and dimmable.
